(19) United States
(12) Patent Application Publication
(10) Pub. No.: US 2018/0349036 A1
(43) Pub. Date: Dec. 6, 2018

(54) Data Storage Map with Custom Map Attribute

(71) Applicant: Seagate Technology LLC, Cupertino, CA (US)

(72) Inventors: Jackson Ellis, Fort Collins, CO (US); Jeffrey Munsil, Fort Collins, CO (US)

(73) Assignee: Seagate Technology LLC

(21) Appl. No.: 15/610,806

(22) Filed: Jun. 1, 2017

(51) Int. Cl. G06F 3/06; G06F 12/10

(52) U.S. Cl. CPC G06F 3/0611; G06F 12/10; G06F 3/064; G06F 2212/7201; G06F 2212/1024; G06F 2212/152; G06F 2212/2022; G06F 3/0679

(57) ABSTRACT

A data storage device can be configured with a data map that has one or more custom map attributes. A non-volatile memory of the data storage device may store data organized into a data map by a mapping module. The data map consisting of at least a data address translation and a custom attribute pertaining to an operational parameter of the data map with the custom attribute generated and maintained by the mapping module.

### SUMMARY

In some embodiments, a non-volatile memory of the data storage device stores data organized into a data map by a mapping module. The data map consists of at least a data address translation and a custom attribute pertaining to an operational parameter of the data map with the custom attribute generated and maintained by the mapping module.

### BRIEF DESCRIPTION OF THE DRAWINGS

FIG. 1 provides a block representation of an exemplary data storage system configured in accordance with various embodiments of the present disclosure.

FIG. 2 shows portions of an example data storage device capable of being used in the data storage system of FIG. 1 in accordance with some embodiments.

FIG. 3 is a block representation of portions of an example data storage device that may be employed in the data storage system of FIG. 1.

FIG. 4 shows an exemplary format for a multi-level map structure arranged in accordance with some embodiments.

FIGS. 5A-5C respectively depict portions of an example data storage system configured in accordance with various embodiments.

FIGS. 6A and 6B respectively display portions of an example data storage system created and utilized in accordance with assorted embodiments.

FIG. 7 illustrates portions of an example data storage system configured in accordance with some embodiments.

FIG. 8 conveys a block representation of portions of an example data storage system employing various embodiments of the present disclosure.

FIG. 9 represents a portion of an example data storage system arranged in accordance with some embodiments.

FIG. 10 is a flowchart of an example intelligent mapping routine that can be carried out with the assorted embodiments of FIGS. 1-9.

### DETAILED DESCRIPTION

Through the assorted embodiments of the present disclosure, data storage device performance can be optimized by implementing a mapping module that controls at least one custom data map attribute that identifies an operational parameter of the data map itself. The addition of a custom data map attribute can complement map attributes that identify operational parameters of the data being mapped to reduce data reading and writing latency while providing optimal data management and placement to service data access requests from local and/or remote hosts.

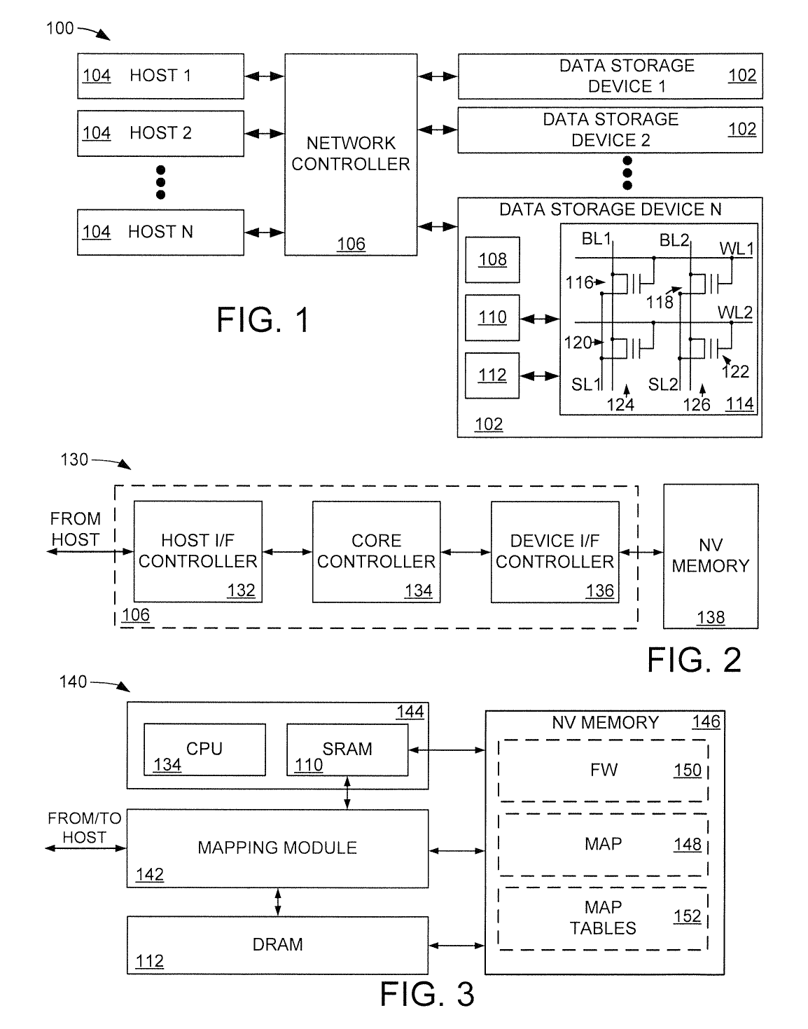

FIG. 1 displays a block representation of an example data storage system 100 in which assorted embodiments of the present disclosure may be practiced. The system 100 can connect any number of data storage device 102 to any number of host 104 via a wired and/or wireless network. One or more network controller 106 can be hardware or software based and provide data request processing and distribution to the various connected data storage devices 102. It is noted that the multiple data storage devices 102 may be similar, or dissimilar, types of memory with different data capacities, operating parameters, and data access speeds.

In some embodiments, at least one data storage device 102 of the system 100 has a local processor 108, such as a microprocessor or programmable controller, connected to an on-chip buffer 110, such as static random access memory (SRAM), and an off-chip buffer 112, such as dynamic random access memory (DRAM), and a non-volatile memory array 114. The non-limiting embodiment of FIG. 1 arranges the non-volatile memory array 114 comprises NAND flash memory that is partially shown schematically with first (BL1) and second (BL2) bit lines operating with first (WL1) and second (WL2) word lines and first (SL1) and second (SL2) source lines to write and read data stored in first 116, second 118, third 120, and fourth 122 flash cells.

It is noted that the respective bit lines correspond with first 124 and second 126 pages of memory that are the minimum resolution of the memory array 114. That is, the construction of the flash memory prevents the flash cells from being individually rewritable in-place and instead are rewritable on a page-by-page basis. Such low data resolution, along with the fact that flash memory wears out after a number of write/rewrite cycles, corresponds with numerous performance bottlenecks and operational inefficiencies compared to memory with cells that are bit addressable while being individually accessible and individually rewritable in-place.

Additionally, a flash memory based storage device, such as an SSD, stores subsequently received versions of a given data block to a different location within the flash memory, which is difficult to organize and manage. Hence, various embodiments are directed to structures and methods that optimize data mapping to the non-volatile memory array 114. It is noted that the non-volatile memory array 114 is not limited to a flash memory and other mapped data structures can be utilized at will.

Data storage devices 102 are used to store and retrieve user data in a fast and efficient manner. Map structures are often used to track the physical locations of user data stored in the main non-volatile memory 114 to enable the device 102 to locate and retrieve previously stored data. Such map structures may associate logical addresses for data blocks received from a host 104 with physical addresses of the media, as well as other status information associated with the data.

Along with the operational difficulties of some non-volatile memories, like NAND flash, the management of map structures can provide a significant processing bottleneck to a storage device controller in servicing access commands (e.g., read commands, write commands, status commands, etc.) from a host device 104. In some embodiments a data storage device is provided with a controller circuit and a main non-volatile memory. The controller circuit provides top level controller functions to direct the transfer of user data blocks between the main memory and a host device. The user data blocks stored in the main memory are described by a data map structure where a plurality of map pages each describe the relationship between logical addresses used by the host device and physical addresses of the main memory along with a custom map attributes that pertains to an operational parameter of the data map itself.

The controller circuit includes a programmable processor that uses programming (e.g., firmware) stored in a memory location to process host access commands. The data map can contain one or more pages for the data associated with each data access command received from a host. The ability to create, alter, and adapt one or more custom map attributes allows the map itself to be optimized by accumulating map-specific performance metrics, such as hit rate, coloring, and update frequency.

FIG. 2 is a functional block representation of an example data storage device 130 that can be utilized in the data storage system 100 of FIG. 1 in accordance with some embodiments. The device 130 generally corresponds to the device 102 and is characterized as a solid-state drive (SSD) that uses two-dimensional (2D) or three-dimensional (3D)

NAND flash memory as the main memory array 114. Other circuits and components may be incorporated into the SSD 130 as desired, but such have been omitted from FIG. 2 for purposes or clarity. The circuits in FIG. 2 may be incorporated into a single integrated circuit (IC) such as a system on chip (SOC) device, or may involve multiple connected IC devices.

It is contemplated that the various aspects of the network controller 106 of FIG. 1 can be physically resident in separate, or a single common structure, such as in a server and data storage device 102. As shown, the network controller 106 can have a host interface (I/F) controller circuit 132, a core controller circuit 134, and a device I/F controller circuit 136. The host I/F controller circuit 132 may sometimes be referred to as a front-end controller or processor, and the device I/F controller circuit 136 may be referred to as a back-end controller or processor. Each controller 132, 134 and 136 includes a separate programmable processor with associated programming, which can be characterized as firmware (FW) in a suitable memory location, as well as various hardware elements, to execute data management and transfer functions. This is merely illustrative of one embodiment; in other embodiments, a single programmable processor (or less than three programmable processors) can be configured to carry out each of the front end, core, and back end processes using associated FW in a suitable memory location.

The front-end controller 122 processes host communications with a host device 104. The back-end controller 136 manages data read/write/erase (R/W/E) functions with a non-volatile memory 138, which may be made up of multiple NAND flash dies to facilitate parallel data operations. The core controller 134, which may be characterized as the main controller, performs the primary data management and control for the device 130.

FIG. 3 shows a block representation of a portion of an example data storage device 140 configured and operated in accordance with some embodiments in a distributed data storage system, such as system 100 of FIG. 1. The data storage device 140 has a mapping module 142 that may be integrated into any portion of the network controller 106 of FIGS. 1 & 2. The mapping module 142 can receive data access requests directly from a host as well as from one or more memory buffer.

In the non-limiting example of FIG. 3, an SRAM first memory buffer 110 is positioned on-chip 144 and connected to the mapping module 142 along with an off-chip DRAM second memory buffer 112. The SRAM buffer 110 is a volatile memory dedicated to temporarily store user data during data transfer operations with the non-volatile (NV) memory 136. The DRAM buffer 112 is also a volatile memory that may be also used to store other data used by the system 100. The respective memories 110, 112 may be realized as a single integrated circuit (IC), or may be distributed over multiple physical memory devices that, when combined, provide an overall available memory space.

A core processor (central processing unit, CPU) 134 is a programmable processor that provides the main processing engine for the network controller 106. The non-volatile memory 146 is contemplated as comprising one or more discrete local memories that can be used to store various data structures used by the core controller 134 to produce a data map 148, firmware (FW) programming 150 used by the core processor 134, and various map tables 152.

At this point it will be helpful to distinguish between the term “processor” and terms such as “non-processor based,” “non-programmable” and “hardware.” As used herein, the term processor refers to a CPU or similar programmable device that executes instructions (e.g., FW) to carry out various functions. The terms non-processor, non-processor based, non-programmable, hardware and the like are exemplified by the mapping module 142 and refer to circuits that do not utilize programming stored in a memory, but instead are configured by way of various hardware circuit elements (logic gates, FPGAs, etc.) to operate. As a result, the mapping module 142 functions as a state machine or other hardwired device that has various operational capabilities and functions such as direct memory access (DMA), search, load, compare, etc.

The mapping module 142 can operate concurrently and sequentially with the memory buffers 110/112 to distribute data to, and from, various portions of the non-volatile memory 146. However, it is noted that the mapping module 142 may be consulted before, during, or after receipt of each new data write request in order to organize the write data associated with the data write request and update/create attributes of the data map 148. That is, the mapping module 142 serves to dictate how and where a data write request is serviced while optimizing future data access operations by creating and managing various map attributes that convey operational parameters about the mapped data as well as the map itself.

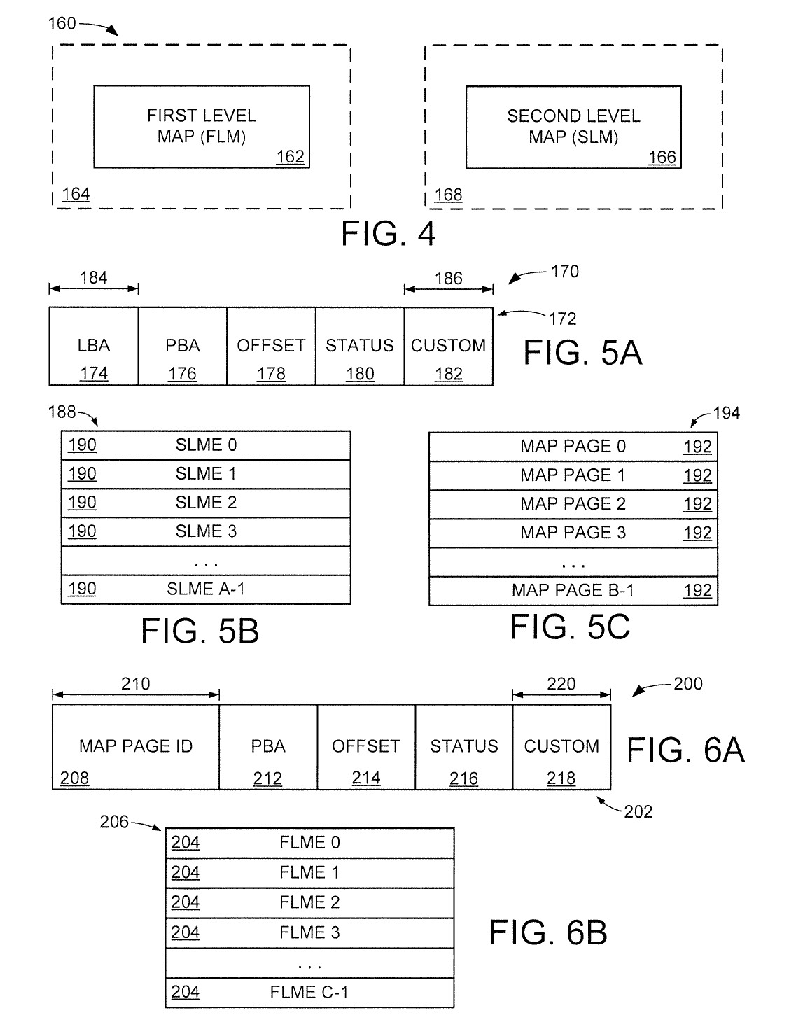

FIG. 4 conveys a block representation of an example multi-level map 160 that can be stored in a memory buffer 110/112 and/or in the main non-volatile memory 146 of a data storage device. Although not required or limiting, the multi-level map 160 can consist of a first level map (FLM) 162 stored in a first memory 164 and a second level map (SLM) 166 stored in a second memory 168. While a two-level map can be employed by a data storage device, other map structures can readily be used, such as a single level map or a multi-level map with more than two levels. It is contemplated that the first 164 and second 168 memories are the same or are different types of memory with diverse operating parameters that can allow different access and updating of the respective maps 162/166.

An example arrangement of a second level map (SLM) 170 is illustrated in FIGS. 5A-5C. The SLM 170 is made up of a data string 172 of consecutive data. The data string 172 can comprise any number, type, and size of data, but in some embodiments consist of the logical block address (LBA) of data 174. the physical block address (PBA) of data 176, a data offset value 178, a status attribute 180, and a custom attribute 182. The LBA values are sequential from a minimum value to a maximum value (e.g., from LBA 0 to LBA N with N being some large number determined by the overall data capacity of the SSD). Other logical addressing schemes can be used such as key-values, virtual block addresses, etc. While the LBA values may form a part of the entries, in other embodiments the LBAs may instead be used as an index into the associated data structure to locate the various entries.

In a typical flash array, data blocks are arranged as pages which are written along rows of flash memory cells in a particular erasure block. The PBA 176 may be expressed in terms of array, die, garbage collection unit (GCU), erasure block, page, etc. The offset value 178 may be a bit offset along a selected page of memory. The status value 180 may indicate the status of the associated block (e.g., valid, invalid, null, etc.). It is noted that the mapping module 132 may create, control, and alter any portion of the data string 172, but particularly the custom map attribute 182. Accordingly, other computing aspects, such as the CPU 124 of FIG. 3, can access, control, and alter other aspects of the data string 172.

For instance, the size 184 of an aspect of the data string 172 can be controlled by some computing aspect of a device/system while the mapping module 132 dictates the size 186 of the custom map attribute 182. Such size 186 control can correspond with the number of different map attributes that are stored in the data string 172. Hence, the custom attribute size 186 may be set by the mapping module 132 to as little as one bit or to as many as several bytes, such as 512 bytes.

A number of data strings 172 can be stored in a second level entry map 188 as second level map entries 190 (SLMEs or entries), in which (A) entries describe individual blocks of user data resident in, or that could be written to, the non-volatile memory 128/136. In the present example, the blocks, also referred to as map units (MUs), are set at 4 KB (4096 bytes) in length, although other sizes can be used. The single level entry map 188 describes the entire possible range of logical addresses of blocks that can be accommodated by the data storage device 130/140, even if certain logical addresses have not been, or are not, used. Groups of SLME 190 are arranged into larger sets of data referred to herein as map pages 192 as part of a single level data map 194. Some selected, non-zero number of entries are provided in each map page. For instance, each map page 192 can have a total of 100 SLME 190. Other groupings of entries can be made in each page 192, such as numbering by powers of 2.

The second level data map 194 constitutes an arrangement of all of the map pages 192 in the system. It is contemplated that some large total number of map pages B will be necessary to describe the entire storage capacity of the data storage device 120/130. Each map page has an associated map ID value, which may be a consecutive number from 0 to B. The second level data map 194 is stored in the main non-volatile memory 138/146, although the data map 194 will likely be written across different sets of the various dies rather than being in a centralized location within the memory 138/146.

Example embodiments of the first level map (FLM) 200 from FIG. 4 are shown as block representations in FIGS. 6A and 6B. The FLM 200 enables the data storage device 120/130 to locate the various map pages 192 stored to non-volatile memory 138/146. To this end, a plurality of first level data strings 202 from FIG. 6A are stored as first level map entries 204 (FLMEs or entries) in the first level entry map 206 of FIG. 6B. Each data string 202 has a map page ID field 208 with a first size 210, a PBA field 212, an offset field 214, a status field 216, and a custom attribute field 218 that has a second size 220. It is noted that the size of the custom attribute 220 can match, be larger than, or be smaller than the page ID size 210

The map ID of the first level data strings 202 can match the LBA field 174 of the second level data string 172. The PBA field 212 describes the location of the associated map page. The offset value 214 operates as before as a bit offset along a particular page or other location. The status value 216 may be the same as in the second level map, or may relate to a status of the map page itself as desired. As before, while the format of the second level data string 202 shows the map ID to form a portion of each entry in the first level map 206, in other embodiments the map IDs may instead be used as an index into the data structure to locate the associated entries.

The first level entry map 206 constitutes an arrangement of all of the entries 204 from entry 0 to entry C. In some cases. B will be equal to C, although these values may be different. Accessing the entry map 206 allows a search, by map ID, of the location of a desired map page within the non-volatile memory 138/146. Retrieval of the desired map page from memory will provide the second level map entries 190 in that map page, and then individual LBAs can be identified and retrieved based on the PBA information in the associated second level entries.

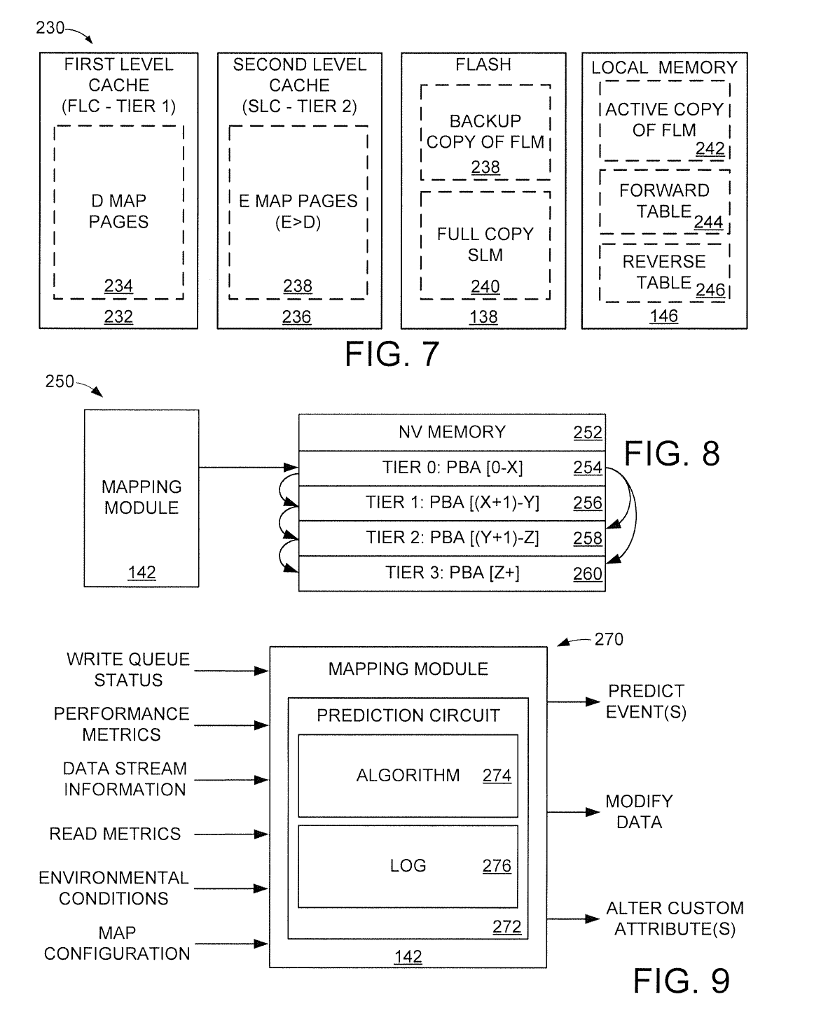

FIG. 7 shows a block representation of portions of an example data storage device 230 that may be utilized in the data storage system of FIG. 1 in some embodiments. The first level cache 232, also referred to as a first cache and a tier 1 cache, is contemplated as a separate memory location, such as an on-board memory of the core controller 134. As discussed above, map pages 234 to be acted upon to service a pending host access command are loaded to the first cache 232. The first level cache 232 is illustrated with a total number D map pages 234. It is contemplated that D will be a relatively small number, such as 128, although other numbers can be used. The size of the first cache is fixed.

The second level cache 236, also referred to as a second cache and a tier 2 cache, is contemplated as constituting at least a portion of the off-chip memory 112. Other memory locations can be used. The size of the second cache 236 may be variable or fixed. The second cache stores up to a maximum number of map pages E, where E is some number significantly larger than D (E>D). As noted above, each of the D map pages in the first cache are also stored in the second cache.

A first memory 138, such as flash memory, is primarily used to store user data blocks described by the map structure 148, but the storage of such is not denoted in FIG. 7. FIG. 7 does show that one or more backup copies 238 of the first level entry map 206 are stored in the non-volatile memory, as well as a lull copy 240 of the second level data map 194. Backup copies of the second level data map 194 may also be stored to non-volatile memory for redundancy, but a reconfiguration of the first level entry map 206 would be required before such redundant copies could be directly accessed. As noted above, the first level entry map 206 points to the locations of the primary copy of the map pages 192 of the second level data map 194 stored in the non-volatile memory 146.

The local non-volatile memory 146 can have an active copy 242 of the first level entry map 206, which is accessed by the mapping module 142 as required to retrieve map pages from memory as necessary to service data access and update requests. The non-volatile memory 146 also stores the map tables 152 from FIG. 3, which are arranged in FIG. 7 as a forward table 244 and a reverse table 246. The forward table 244, also referred to as a first table, is a data structure which identifies logical addresses associated with each of the map pages 238 stored in the second cache 236. The reverse table 246, also referred to as a second table, identifies the physical addresses at which each of the map pages 238 are stored in the second cache 236.

The forward table 244 can be generally viewed as an LBA to off-chip memory 112 conversion table. By entering a selected LBA (or other input value associated with a desired logical address), the associated location in the second cache 236 (DRAM memory in this case) for that entry may be located. The reverse table 246 can be generally viewed an off-chip memory 112 to LBA conversion table. By entering a selected physical address within the second cache 236 (DRAM memory), the associated LBA (or other value associated with the desired logical address) may be located.

In FIG. 8, a portion of an example data storage device 250 is represented as configured in accordance with various embodiments. A mapping module 142 can access and control portions of a non-volatile (NV) memory 252, which may be the same, or different than, the memories 138 and 146. The non-volatile memory 252 can be arranged into a plurality of different tiers by the mapping module 142 in conjunction with a local controller 134. The mapping module 142 can create, move, and alter the respective tiers of the non-volatile memory 252 to proactively and/or reactively optimize the servicing of data access requests to the data storage device 250 as well as the mapping of those data access requests.

Although not limiting or required, the assorted tiers of the non-volatile memory 252 may be virtualized as separate memory regions resident in a single memory structure, which may correspond with separate maps, cache, controllers, and/or remote hosts. In some embodiments, the respective tiers of the non-volatile memory 252 are resident in physically separate memories, such as different types of memory with different capacities and/or data access latencies. Regardless of the physical position of the assorted tiers, the ability of the mapping module 142 to create and modify the number, size, and function of the various tiers allows for adaptive mapping schemes that can optimize data storage performance, such as data access latency and error rate.

The mapping module 142 can generate and employ at least one memory tier as the first level cache 232 and/or second level cache 236 of FIG. 7. By adapting to current, and forecasted, system conditions and events, the mapping module 142 can utilize any number of tiers to temporarily, or permanently, store a data string 172/202, entry map 188/206, and/or data map 206, which can decrease the processing and time expense associated with updating the various mapping structures.

In the non-limiting example of FIG. 8, the mapping module 142 organizes the non-volatile memory 252 into a hierarchical structure where a first tier 254 is assigned a first PBA range, a second tier 256 assigned to a second PBA range, a third tier 258 assigned to a third PBA range, and fourth tier 260 assigned to a fourth PBA range. The non-overlapping ranges of the respective tiers 254/256/258/260 may, alternatively, be assigned to LBAs.

As shown by solid arrows, data may flow between any virtualized tiers as directed by the mapping module 142. For instance, data may consecutively move through the respective tiers 254/256/258/260 depending on the amount of updating activity, which results in the least accessed data being resident in the fourth tier 260 while the most frequently updated data is resident in the first tier 254. Another non-limiting example involves initially placing data in the first tier 254 before moving the data to other, potentially non-consecutive, tiers to allow for more efficient storage and retrieval, such as based on data size, security, and/or host origin.

The creation of various virtualized tiers is not limited to the non-volatile and may be employed on volatile memory, cache, and buffers, such as the on-chip 110 and off-chip 112 buffers. It is contemplated that at least one virtualized tier is utilized by the mapping module to maintain operating parameters of the data storage system, data storage device(s) of the system, and map(s) describing data stored in the data storage system. That is, the mapping module 142 can temporarily, or permanently, store operating data specific to the system, device(s), and map(s) comprising an interconnected distributed network. Such storage of performance and operating parameters allows the mapping module 142 to efficiently evaluate the real-time performance of a data storage system and device as well as accurately forecast future performance as a result of predicted events.

FIG. 9 conveys a block representation of a portion of an example data storage device 270 that employs a selection module 142 having a prediction circuit 272 operated in accordance with various embodiments. The prediction circuit 272 can detect and/or poll a diverse variety of information pertaining to current, and past, data storage operations as well as environmental conditions during such operations. It is noted that the prediction circuit 272 may utilize one or more real-time sensors to detect one or more different environmental conditions, such as device operating temperature, ambient temperature, and power consumption.

With the concurrent and/or sequential input of one or more parameters, as shown in FIG. 9, the prediction circuit 272 can forecast the occurrence of future events that can be accommodated as directed by the mapping module 272. For instance, the mapping module 272 can modify the number, size, and type of operational parameter being stored by a custom attribute 182/218 to maintain data access latency and error rates throughout a predicted event.

Although not exhaustive, the prediction circuit 272 can receive information about the current status of a write queue, such as the volume and size of the respective pending write requests in the queue. The prediction circuit 272 may also poll, or determine, any number of system/device/map performance metrics, like write latency, read latency, and error rate. Stream information for pending data, or data already written, may be evaluated by the prediction circuit 272 along with read metrics, like data read access locations and volume, to establish how frequently data is being written and read.

One or more environmental conditions can be sensed in real-time and/or polled by the prediction circuit 272 to determine trends and situations that likely indicate future data storage activity. The configuration of one or more data maps, such as the first level map and/or second level map, informs the prediction circuit 272 of the physical location of the various maps and map tiers as well as the current arrangement of the data string(s) 172/202, particularly the number and type of map-specific operational parameters described by the custom attributes 182/218.

The prediction circuit 272 can employ one or more algorithms 274 and at least one log 276 of previous data storage activity to forecast the events and accommodating actions that can optimize the servicing of read and write requests. It is contemplated that the log 276 consists of both previously recorded and externally modeled events, actions, and system conditions. The logged information can be useful to the mapping module 142 in determining the accuracy of predicted events and the effectiveness of proactively taken actions. Such self-assessment can be used to update the algorithm(s) 274 to improve the accuracy of predicted events.

By determining the accuracy of previously predicted events, the prediction module 272 can assess a risk that a predicted action will occur and/or the chances of the accommodating actions will optimize system performance. Such ability allows for the prediction module 272 to operate with respect to thresholds established by the mapping module 142 to ignore predicted events and proactive actions that are less likely to increase system performance, such a 95% confidence that an event will happen or a 90% chance a proactive action will increase system performance.

With the ability to ignore less than likely predicted events and proactive actions, the mapping module 142 can concurrently and sequentially generate numerous different scenarios, such as with different algorithms 274 and/or logs 276. As a non-limiting example, the prediction circuit 272 may be tasked with predicting events, and corresponding correcting actions, based on modeled logs alone, real-time system conditions alone, and a combination of modeled and real-time information. In response to the predicted event(s), the mapping module 142 can modify the data, such as by dividing consecutive data into separate data subsets.

The predicted event(s) may also trigger the mapping module 142 to alter the custom attribute of the first level map and/or the second level map. As a result, the custom attributes 182/218 can be different and uniquely identify the operating parameters of the respective maps, such as data access policy, coloring, and map update frequency, without characterizing the data being mapped or the other map(s). Accordingly, the prediction circuit 272 and mapping module 142 can assess system conditions to generate reactive and proactive actions that have a high chance of improving the mapping and servicing of current, and future, data access requests to a data storage device.

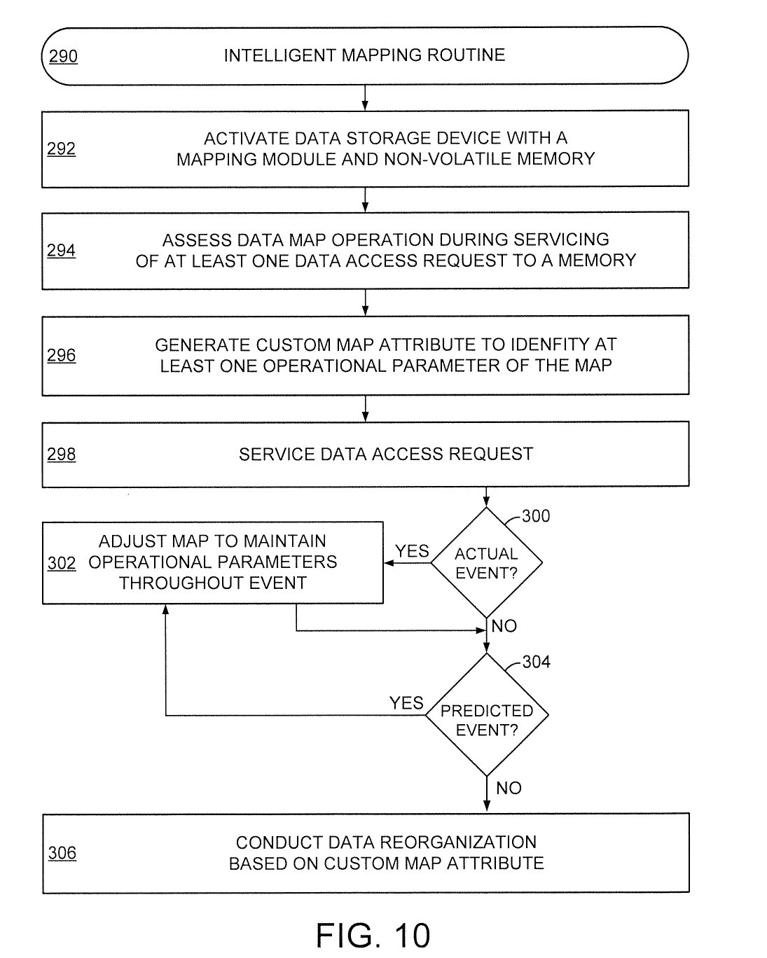

FIG. 10 is a flowchart of an example intelligent mapping routine 290 that can be carried out with the assorted embodiments of FIGS. 1-9 in accordance with some embodiments. Initially, routine 290 can activate one or more data storage devices in step 292 as part of a distributed network data storage system, such as the example system 100 of FIG. 1. Each data storage device of the data storage system can have a non-volatile memory accessed by a mapping module. That is, a data storage system can have one or more mapping modules resident in each data storage device, or in a centralized server that connects with data storage devices that do not have individual mapping modules.

It is noted that the mapping module in step 292 can create or load at least one data map that translates logical-to-physical addresses for data stored one or more data storage devices. The data map in step 292 may, or may not, have a custom attribute when step 294 assesses the data map operation while servicing at least one data access request from a host to the memory of a data storage device. Step 292 may involve the creation and/or updating of entries/pages in the data map. In some embodiments, the data map of step 294 is a two-level map similar to the mapping scheme discussed with FIGS. 4-7, although a single-level data map may be employed.

The assessment of data map operation in step 294 provides system and device operating parameters that can be used in step 296 to generate one or more custom map attributes that identify at least one operational parameter of the map itself That is, the data map can contain a plurality of parameters identifying the data stored in memory of one or more data storage devices along with custom map attributes that identify operating parameters of the map. For instance, the mapping module can generate a custom map attribute in step 296 that identifies the number of host-based hits to the map, the coloring of the map, stream identification, read/write map policies, and tags relating to location, size, and status of the map. These custom map attributes can complement, and operate independently of data-based attributes, such as offset and status fields.

While the generation of one or more custom map attributes can trigger routine 290 to cycle back to step 294 where map operation is assessed and attributes are then created and/or modified in step 296, various embodiments service one or more data access requests in step 298 with the custom map attributes of step 296. Step 298 may be conducted any number of times for any amount of time to provide individual, or concurrent, data reading/writing to one or more data storage devices of the data storage system.

At any time during, or after, step 298, decision 300 can evaluate if an unexpected event is actually happening in real-time in the data storage system. For instance, data access errors, high data access latency, and power loss are each non-limiting unexpected events that can trigger step 302 to adjust one or more data maps to maintain operational parameter levels throughout the event. In other words, step 302 can temporarily, or permanently, modify a data map, mapped data, the custom map attribute, or any combination thereof to react to the unexpected event and maintain system performance throughout the event. It is contemplated that step 302 may not precisely maintain system performance and instead mitigate performance degradation as a result of the unexpected event.

When the unexpected event is over, or if step 302 has completed adaptation to the unexpected event, decision 304 evaluates if an event is predicted by the prediction circuit of a mapping module. Decision 304 can assess the number, accuracy, and effects of forecasted events before determining if step 302 is to be executed. If so, step 302 proactively modifies one or more maps, map attributes, or data of the map in anticipation of the predicted event coming true. As shown, decision 304 and step 302 can be revisited any number of times to adapt the map, and/or map data, to a diverse variety of events and system conditions to maintain data access performance despite potentially performance degrading events occurring.

At the conclusion of decision 304 when no actual or predicted events are occurring or forecasted, the data of at least one data storage device is reorganized in step 306 based on the information conveyed by the custom map attribute(s). For example, garbage collections operations can be conducted in step 306 with optimal data mapping and placement due to the custom map attribute identifying one or more characteristics of the data map itself. Such data reorganization based, in part, on the custom map attribute(s) can maintain streaming data cohesiveness during garbage collection by storing stream identification information with data and temporal identification information inside a garbage collection unit.

In the embodiments that employ a two-level map, routine 290 may be sequentially, or concurrently executed for each data map. As a non-limiting example, decisions 300 and 304 can be conducted simultaneously for different data maps, which can result in different custom map attributes being stored for the respective first and second level maps. Although custom map attributes may he of the same type for each data map, the operating parameters of the respective maps will be different and will result in different custom map attribute values.

The availability of different custom map attributes in multi-level maps allows the custom map attributes to be arranged to complement each other. For instance, a first level map custom attribute may provide read/write policy information that aids in the evaluation and data access updating of the second level map where tracks host-based hits to the second level map. It is noted that the custom map attributes of maps can be reorganized, or resequentialized, in step 306. The various aspects of routine 290 can provide optimized data mapping and servicing of data access requests. However, the assorted steps and decisions are not required or limiting and any portion of routine 290 can be changed or removed, just as anything can be added to the routine 290.

Through the various embodiments discussed with FIGS. 1-10, a mapping module can create, modify, and maintain at least one custom map attribute that identifies an operational parameter for one or more data maps. The combination of the map translating logical-to-physical addresses for data stored in an associated memory and the custom map attribute identifying operating parameters for the map itself provides increased capabilities for a controller to identify and accommodate actual and potential performance degrading events. The ability to accurately forecast future performance degrading events allows a mapping module to proactively adapt a data map, and the associated data, to maintain operational conditions throughout the predicted event.

It is to be understood that even though numerous characteristics and advantages of various embodiments of the present disclosure have been set forth in the foregoing description, together with details of the structure and function of various embodiments of the disclosure, this detailed description is illustrative only, and changes may be made in detail, especially in matters of structure and arrangements of parts within the principles of the present disclosure to the full extent indicated by the broad general meaning of the terms in which the appended claims are expressed.

1. An apparatus comprising a data storage device having a non-volatile memory storing data organized into a data map by a mapping module, the data map comprising a data address translation and a custom attribute pertaining to an operational parameter of the data map, the custom attribute generated and maintained by the mapping module.

2. The apparatus of claim 1, wherein the data address translation is from a logical block address to a physical block address in the non-volatile memory.

3. The apparatus of claim 1, wherein the custom attribute has a size of a single bit.

4. The apparatus of claim 1, wherein the custom attribute has a size of multiple bytes.

5. The apparatus of claim 1, wherein the data map comprises a plurality of data pages, each data page comprising a data string having a logical block address, physical block address, offset value, and status value.

6. The apparatus of claim 5, wherein the offset value and status value each identify data stored in the non-volatile memory.

7. The apparatus of claim 1, wherein the non-volatile memory is NAND flash.

8. The apparatus of claim 1, wherein the custom attribute has a smaller size than a logical block address of the data map.

9. The apparatus of claim 1, wherein the custom attribute identifies multiple different operational parameters of the data map.

10. A data storage device comprising a non-volatile memory storing data organized into a first data map and a second data map by a mapping module, the second data map comprising a first custom attribute pertaining to one or more operational parameters of the first data map, the first custom attribute generated and maintained by the mapping module.

11. The data storage device of claim 10, wherein the first data map describes each individual blocks of data resident in, the non-volatile memory.

12. The data storage device of claim 11, wherein the second data map identifies the location of each portion of the first data map.

13. The data storage device of claim 10, wherein the first and second data maps are stored in different types of memory.

14. The data storage device of claim 10, wherein the second data map comprises a second custom attribute pertaining to at least one operational parameter of the second data map.

15. The data storage device of claim 14, wherein the first and second custom attributes are different.

16. The data storage device of claim 14, wherein the first and second custom attributes are a common type of operational parameter and are different values.

17. A method comprising:
organizing a data storage device having a non-volatile memory storing data into a data map by a mapping module;
generating a custom attribute with the mapping module, the custom attribute pertaining to an operational parameter of the data map; and
maintaining the custom attribute with the mapping module in response to changing conditions in the data storage device.

18. The method of claim 17, wherein the mapping module identifies an unexpected event occurring in real-time and adjusts the custom attribute to maintain data storage device performance throughout the unexpected event.

19. The method of claim 17, wherein the mapping module predicts an event occurring and proactively adjusts the custom attribute to maintain data storage device performance throughout the predicted event.

20. The method of claim 17, wherein the mapping module predicts multiple different events and discards at least one predicted event in response to the accuracy of the predicted event being below an accuracy threshold.
